(19) United States
(12) Patent Application Publication
(10) Pub. No.: US 2018/0275919 A1
(43) Pub. Date: Sep. 27, 2018

(54) PREFETCHING DATA IN A DISTRIBUTED STORAGE SYSTEM

(71) Applicant: HEWLETT PACKARD ENTERPRISE DEVELOPMENT LP, Houston, TX (US)

(72) Inventors: Narendra Chirumamilla, Bangalore (IN); Ranjith Reddy Basireddy, Bangalore (IN); Keshetti Mahesh, Bangalore (IN); Taranisen Mohanta, Bangalore (IN); Satish Kumar Gandham, Bangalore (IN)

(21) Appl. No.: 15/761,984

(22) PCT Filed: Mar. 25, 2016
(86) PCT No.: PCT/US2016/024254

§ 371 Date: Mar. 21, 2018

(30) Foreign Application Priority Data
Dec. 23, 2015 (IN) 6871/CHE/2015

(51) Int. Cl. G06F 3/06

(52) U.S. Cl. CPC G06F 3/0659; G06F 3/067; G06F 3/0611

(57) ABSTRACT

Some examples relate to prefetching data in a distributed storage system. In an example, a first storage node may receive I/O requests sent by a host system, for sequential data of a storage volume distributed across a plurality of storage nodes. The first storage node may determine whether the host system is aware or unaware of layout information of the storage volume. If the host system is unware, the first storage node may prefetch the sequential data of the storage volume from other nodes of the plurality of storage nodes. If the host system is aware, the first storage node may indicate to a second storage node that the I/O requests by the host system are for the sequential data of the storage volume.

### BACKGROUND

Storage systems have become an integral part of modern day computing. Whether it is a small start-up or a large enterprise, organizations these days may need to deal with a vast amount of data that could range from a few terabytes to multiple petabytes. Storage systems or devices provide a useful way of storing and organizing such large amounts of data. Enterprises may be looking at more efficient ways of utilizing their storage resources.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for prefetching data in a distributed storage system;

FIG. 2 is a block diagram of an example system for prefetching data in a distributed storage system;

FIG. 3 is a flowchart of an example method of prefetching data in a distributed storage system; and

FIG. 4 is a block diagram of an example system for prefetching data in a distributed storage system.

### DETAILED DESCRIPTION

Data management may be important to the success of an organization. Whether it is a private company, a government undertaking, an educational institution, or a new start-up, managing data (for example, customer data, vendor data, patient data, etc.) in an appropriate manner is crucial for existence and growth of an enterprise. Storage systems play a useful role in this regard. A storage system allows an enterprise to store and organize data, which may be analyzed to derive useful information for a user.

Typically, in a distributed storage system, multiple storage nodes may be interconnected with each other. Data of volumes created on a distributed storage system may be spread across multiple storage nodes. Since volume data is distributed across multiple storage nodes, a prefetch algorithm running on each individual storage node may detect sequential read pattern and prefetch (or cache) data pages of the volume residing on that node. This kind of prefetch mechanism in a distributed storage system may be inefficient, for instance, if all the I/O requests specific to a volume is received on one storage node. In other words, the host system to which the volume is presented may be unaware of volume region or layout information. If volume layout information is not known to the host system, the host system issues all the I/O requests to the gateway node of the storage system to which the volume is associated. Since the gateway node doesn't have the data blocks of the volume residing on other storage nodes, the gateway node may redirect the I/O request to the storage node on which data resides, receive result and return the result back to the host system. In this case, data caching on every individual node of the storage system may not be sufficient. In another instance, in a distributed storage system there may be no synchronization between the prefetch modules running on individual storage nodes. If a sequential read is detected on a node, due to the distributed nature of storage, a successive data block may reside on another storage node in the storage system. There is no existing mechanism to inform this next storage node to prefetch the pages of next successive data block. Instead, the next storage node may process I/O request, identify the read as sequential, and then prefetch pages to cache. Needless to say, these approaches to prefetching data are inefficient.

To address this issue, the present disclosure describes various examples for prefetching data in a distributed storage system. In an example, a first storage node amongst a plurality of storage nodes in a distributed storage system may receive I/O requests sent by a host system, for sequential data of a storage volume distributed across the plurality of storage nodes. In response, the first storage node may determine whether the host system is aware or unaware of layout information of the storage volume. If the host system is tinware of layout information of the storage volume, the first storage node may prefetch the sequential data of the storage volume from other nodes of the plurality of storage nodes. On the other hand, if the host system is aware of layout information of the storage volume, the first storage node may indicate to a second storage node amongst the plurality of storage nodes that the I/O requests by the host system are for the sequential data of the storage volume, before the host system issues the I/O requests for the sequential data to the second storage node.

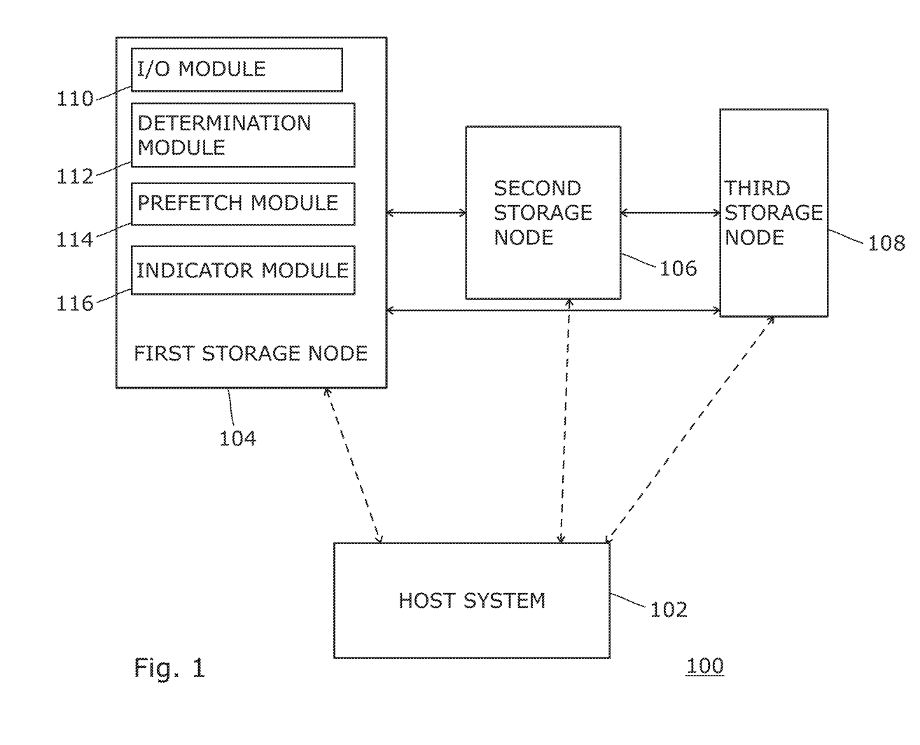

FIG. 1 is a block diagram of an example computing environment 100 for prefetching data in a distributed storage system. In an example, computing environment 100 may include a computing device 102, a first storage node 104, a second storage node 106, and a third storage node 108. Although only one computing device and three storage nodes are shown in FIG. 1, other examples of this disclosure may include more than one computing device, and more or less than three storage nodes.

Computing device (or host system) 102 may represent any type of computing system capable of reading machine-executable instructions. Examples of computing device 102 may include, without limitation, a server, a desktop computer, a notebook computer, a tablet computer, a thin client, a mobile device, a personal digital assistant (PDA), a phablet, and the like. In an example, computing device 102 may be a file server system or file storage system.

Storage nodes (i.e. 104, 106, and 108) may each be a storage device. The storage device may be an internal storage device, an external storage device, or a network attached storage device. Some non-limiting examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, storage nodes may each be a Direct Attached Storage (DAS) device, a Network Attached Storage (NAS) device, a Redundant Array of Inexpensive Disks (RAID), a data archival storage system, or a block-based device over a storage area network (SAN). In another example, storage nodes may each be a storage array, which may include one or more storage drives (for example, hard disk drives, solid state drives, etc.). In an instance, storage nodes may each be a storage server.

In an example, storage nodes (for example, 104, 106, and 108) may be part of a distributed storage system. Storage nodes may be in communication with each other, for example, via a computer network. Such a computer network may be a wireless or wired network. Such a computer network may include, for example, a Local Area Network (LAN), a Wireless Local Area Network (WAN), a Metropolitan Area Network (MAN), a Storage Area Network (SAN), a Campus Area Network (CAN), or the like. Further, such a computer network may be a public network (for example, the Internet) or a private network (for example, an intranet). Computing device 102 may be in communication with any or all of the storage nodes, for example, via a computer network 106. Such a computer network may be similar to the computer network described above.

Storage nodes (for example, 104, 106, and 108) may communicate with computing device via a suitable interface or protocol such as, but not limited to, Fibre Channel, Fibre Connection (FICON), Internet Small Computer System Interface (iSCSI), HyperSCSI, and ATA over Ethernet.

In an example, physical storage space provided by storage nodes (for example, 104, 106, and 108) may be presented as a logical storage space to computing device 102. Such logical storage space (also referred as “logical volume”, “virtual disk”, or “storage volume”) may be identified using a “Logical Unit Number” (LUN). In another instance, physical storage space provided by storage nodes may be presented as multiple logical volumes to computing device 102. In such case, each of the logical storage spaces may be referred to by a separate LUN. In an example, a storage volume may be distributed across all storage nodes.

Storage nodes (for example, 104, 106, and 108) may each provide block level storage. In an example, a logical storage space (or logical volume) may be divided into blocks. A “block” may be defined as a sequence of bytes or bits, having a nominal length (a block size). Data (for example, a file) may be organized into a block. A block may be of fixed length or variable length. A block may be defined at a logical storage level or at physical storage disk level. In an instance, file system on computing device 102 may use a block to store a file or directory in a logical storage space. In another example, a file or directory may be stored over multiple blocks that may be located at various places on a volume. In context of a physical storage space, a file or directory may be spread over different physical areas of a storage medium.

In an example a storage node (for example, first storage node 104) may include an I/O module 110, a determination module 112, a prefetch module 114, and an indicator module 116. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a computing device (e.g. 102).

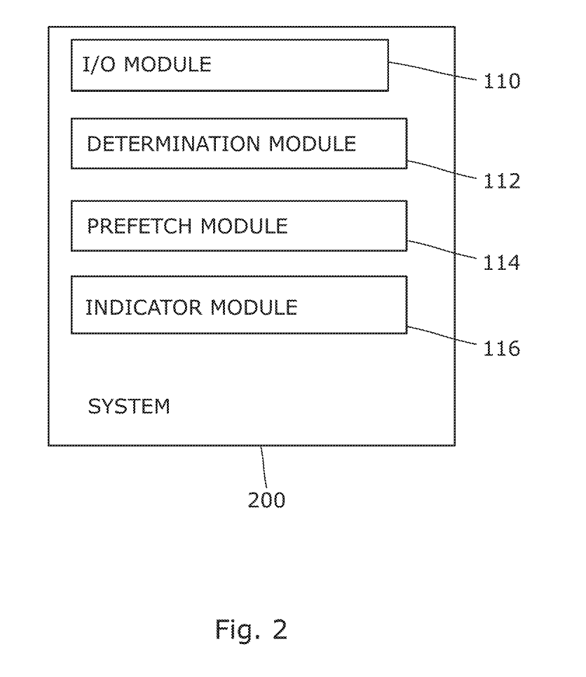

Some of the example functionalities that may be performed by I/O module 110, determination module 112, prefetch module 114, and indicator module 116 are described in reference to FIG. 2 below.

In an example, a first storage node (for example, 102) amongst a plurality of storage nodes (for example, 102, 104, and 106) may receive I/O requests sent by a host system (for example, 102), for sequential data of a storage volume distributed across the plurality of storage nodes. In other words, a first storage node may receive I/O requests for sequential blocks of data of a storage volume that may be present on a plurality of storage nodes. In an instance, the plurality of storage nodes, including the storage node, may be part of a distributed storage system. In an instance, the first storage node may receive I/O requests sent by the host system in a sequential manner.

In response, the first storage node 104 may determine whether the host system is aware or unaware of layout information of the storage volume. In an instance, the first storage node 104 may make the determination by determining whether a Device Specific Module (DSM) is present on the host system. A DSM module may include information related to a storage device's hardware. In an instance, a DSM module may include information related to hardware of a storage node(s) (for example, first storage node, second storage node, and third storage node). In an example, the DSM module may be a Multipath I/O (MPIO)-based module. MPIO is a framework that allows more than one data path between a computer system and a storage device. MPIO may be used to mitigate the effects of a storage controller failure by providing an alternate data path between a computer system and a storage device.

If a DSM is present on the host system, it may act as an indication to the first storage node 104 that the host system is aware about the layout or region information of the storage volume that is distributed across the plurality of storage nodes. If a DSM is not present on the host system, it may act as an indication to the first storage node that the host system is unaware about the layout or region information of the storage volume that is distributed across the plurality of storage nodes.

In one example, if the first storage node 104 determines that the host system 102 is unaware about the layout or region information of the storage volume that is distributed across the plurality of storage nodes, the first storage node may prefetch sequential data of the storage volume from other nodes of the plurality of storage nodes. In an example, the first storage node 104 may first process the I/O requests meant for sequential data stored thereon, identify the sequential nature of data, and upon receipt of I/O requests meant for sequential data stored on other storage nodes, prefetch the sequential data stored on other storage nodes to its own cache or memory. In other words, instead of forwarding the I/O requests meant for sequential data stored on other storage nodes, to respective storage nodes, the first storage node may prefetch the sequential data stored on respective storage nodes to its own cache or memory. This approach results in efficient processing of I/O requests from the host system and avoids the overhead of I/O requests redirection to other nodes in the storage system.

In another example, if the host system 102 is aware about the layout information of the storage volume that is distributed across the plurality of storage nodes, the host system may issue I/O requests to each of the plurality of storage nodes separately. In such case, in an example, if the first storage node 104 determines that the host system is aware about the layout information of the storage volume that is distributed across the plurality of storage nodes, the first storage node may first identify the sequential nature of data and, upon such identification, the first storage node may indicate to a second storage node (for example, 106) amongst the plurality of storage nodes that the I/O requests by the host system are for the sequential data of the storage volume. The second storage node 106 may include a portion of the sequential data that is successive to sequential data present on the first storage node. The first storage node may include the first part of the sequential data. In an instance, the first storage node may provide an indication to the second storage node that the I/O requests by the host system are for the sequential data of the storage volume, before the host system issues the I/O requests for the sequential data to the second storage node.

In an example, in response to receiving the indication from the first storage node 104, the second storage node 106 may prefetch sequential data of the storage volume present thereon. In other words, the second storage node may not wait to receive I/O requests from the host system to fetch the sequential data stored thereon. Upon receiving the indication from the first storage node, the second storage node may prefetch sequential data of the storage volume present thereon.

In an example, in response to receiving the indication from the first storage node 104, the second storage node 106 may indicate to a third storage node (for example, 108) that the I/O requests by the host system are for the sequential data of the storage volume, before the third storage node receives the I/O requests for the sequential data from the host system. Upon receiving the indication from the second storage node, the third storage node 108 may prefetch sequential data of the storage volume present thereon. Likewise, in case there are more storage nodes that include sequential data of the storage volume, each node may provide an indication to a respective next storage node that includes successive sequential data of the storage volume until, for instance, all I/O requests from the host are processed.

FIG. 2 is a block diagram of an example system 200 for prefetching data in a distributed storage system. In an example, system 200 may be analogous to a storage node (for example, first storage node 104) of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. The components or reference numerals may be considered alike.

Storage system 200 may be an internal storage device, an external storage device, or a network attached storage device. Some non-limiting examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, storage system may be a Direct Attached Storage (DAS) device, a Network Attached Storage (NAS) device, a Redundant Array of Inexpensive Disks (RAID), a data archival storage system, or a block-based device over a storage area network (SAN). In another example, storage system may be a storage array, which may include one or more storage drives (for example, hard disk drives, solid state drives, etc.). In an instance, storage system may each be a storage server.

In an example, storage system 200 may include an I/O module 110, a determination module 112, a prefetch module 114, and an indicator module 116.

I/O module 110 may receive I/O requests issued by a host system (for example, 102) for sequential block data of a storage volume that may be distributed across a plurality of storage systems (for example, 106 and 108) including storage system. In other words, I/O module may receive I/O requests for sequential blocks of data of a storage volume that may be present on a plurality of storage nodes. In an instance, the plurality of storage nodes, including the storage node, may be part of a distributed storage system. In an instance, the I/O module may receive I/O requests sent by the host system in a sequential manner.

Determination module 112 may determine whether the host system is aware or unaware of layout information of the storage volume. In an instance, the determination module may make the determination by determining whether a Device Specific Module (DSM) is present on the host system. In an instance, a DSM module may include information related to hardware of a storage node(s) (for example, first storage node, second storage node, and third storage node).

If a DSM is present on the host system, it indicates to the determination module that the host system is aware about the layout or region information of the storage volume that is distributed across the plurality of storage nodes. If a DSM is not present on the host system, it indicates to the determination module that the host system is unaware about the layout or region information of the storage volume that is distributed across the plurality of storage nodes.

Prefetch module 116 may prefetch the sequential block data of the storage volume from the plurality of storage nodes, if the host system is unware of layout information of the storage volume. In other words, if the determination module determines that the host system is unaware about the layout or region information of the storage volume that is distributed across the plurality of storage nodes, the prefetch module 116 may prefetch sequential block data of the storage volume from other nodes of the plurality of storage nodes. In an example, the prefetch module 116 may first process the I/O requests meant for sequential block data stored thereon, identify the sequential nature of data, and upon receipt of I/O requests meant for sequential data stored on other storage nodes, prefetch the sequential data stored on other storage nodes to its own cache or memory. In other words, instead of forwarding the I/O requests meant for sequential data stored on other storage nodes, to respective storage nodes, the prefetch module 116 may prefetch the sequential block data stored on respective storage nodes to its own cache or memory.

In an example, if the host system is aware about the layout information of the storage volume that is distributed across, the plurality of storage nodes, the host system may issue I/O requests to each of the plurality of storage nodes separately. In such case, in an example, if the determination module 112 determines that the host system is aware about the layout information of the storage volume that is distributed across the plurality of storage nodes, the indicator module 118 may first identify the “sequential” nature of data and, upon such identification, the indicator module 118 may indicate to a second storage node amongst the plurality of storage nodes that the I/O requests by the host system are for the sequential data of the storage volume. The second storage node may include a portion of the sequential data that is successive to sequential data present on the first storage node. The first storage node may include the first part of the sequential data. In an instance, the indicator module 118 may provide an indication to the second storage node that the I/O requests by the host system are for the sequential data of the storage volume, before the host system issues the I/O requests for the sequential data to the second storage node.

In an example, in response to receiving the indication from the indicator module 118, the second storage node may prefetch sequential data of the storage volume present thereon. In other words, the second storage node may not wait to receive I/O requests from the host system to fetch the sequential data stored thereon. Upon receiving the indication from the indicator module 118, the second storage node may prefetch sequential data of the storage volume present thereon.

In an example, in response to receiving the indication, the second storage node may indicate to a third storage node that the I/O requests by the host system are for the sequential data of the storage volume, before the third storage node receives the I/O requests for the sequential data from the host system. Upon receiving the indication from the second storage node, the third storage node may prefetch sequential data of the storage volume present thereon. Likewise, in case there are more storage nodes that include sequential data of the storage volume, each node may provide an indication to a respective next storage node that includes successive sequential data of the storage volume until, for instance, all I/O requests from the host are processed.

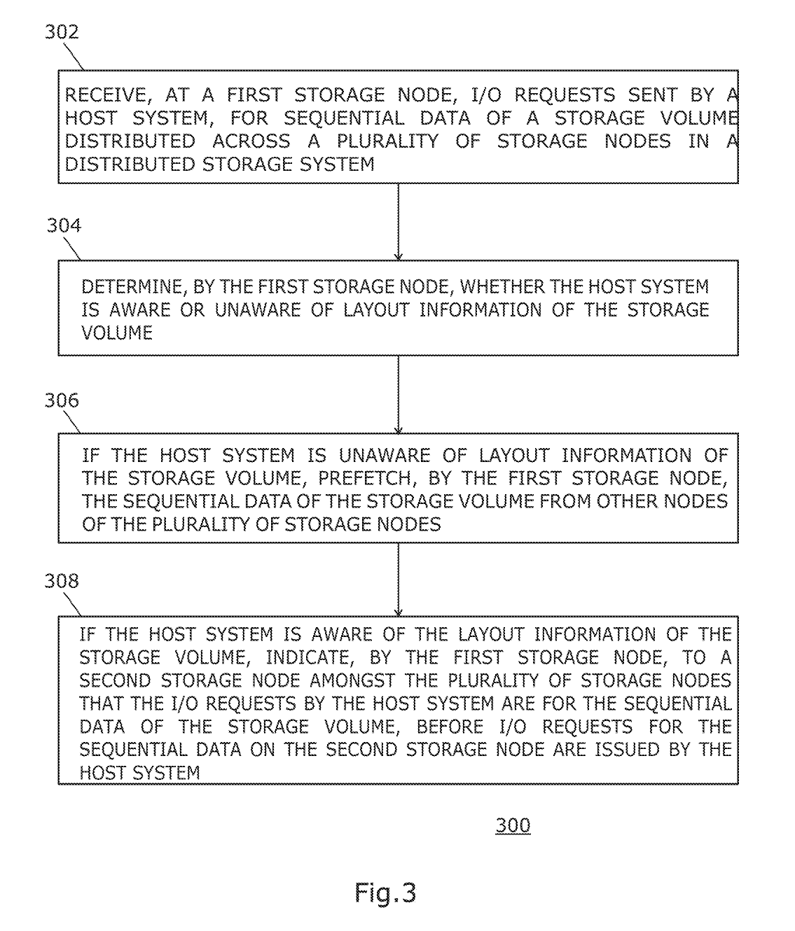

FIG. 3 is a flowchart of an example method 300 for prefetching data in a distributed storage system. The method 300, which is described below, may at least partially be executed on a storage system, for example, storage nodes 104, 106, and 108 of FIG. 1 or storage system 200 of FIG. 2. However, other computing devices may be used as well. At block 302, a first storage node amongst a plurality of storage nodes in a distributed storage system may receive I/O requests sent by a host system, for sequential data of a storage volume distributed across the plurality of storage nodes. At block 304, the first storage node may determine whether the host system is aware or unaware of layout information of the storage volume. At block 306, if the host system is unware of layout information of the storage volume, the first storage node may prefetch the sequential data of the storage volume from other nodes of the plurality of storage nodes. At block 308, if the host system is aware of layout information of the storage volume, the first storage node may indicate to a second storage node amongst the plurality of storage nodes that the I/O requests by the host system are for the sequential data of the storage volume, before the host system issues the I/O requests for the sequential data to the second storage node.

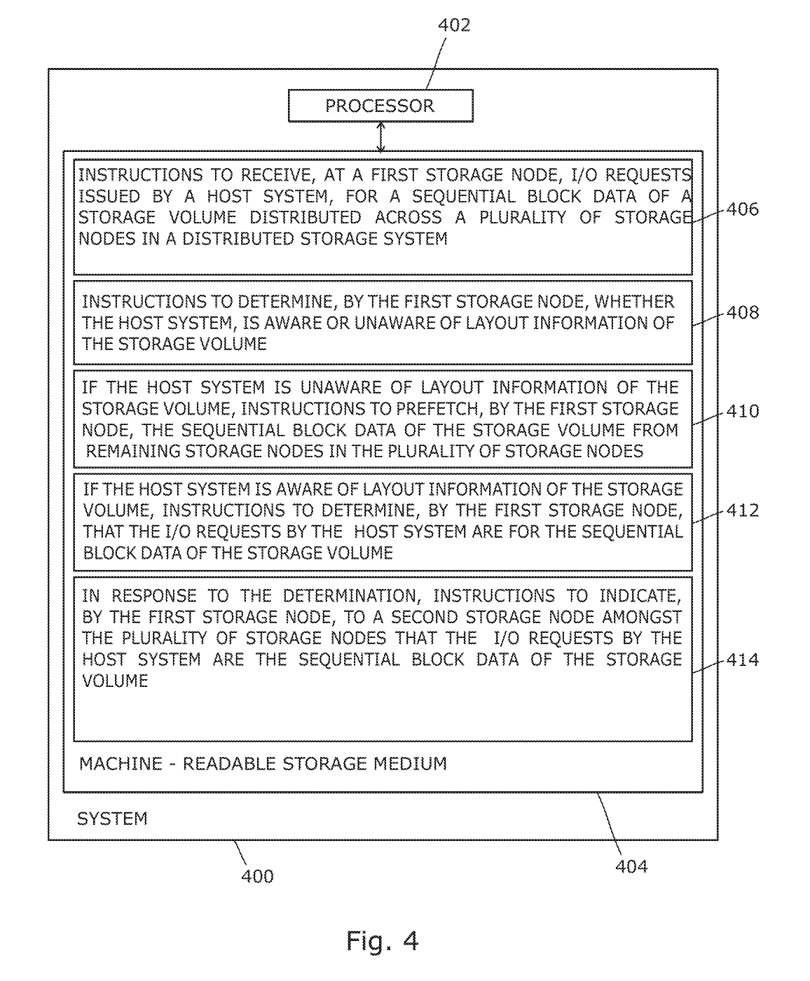

FIG. 4 is a block diagram of an example system 400 for prefetching data in a distributed storage system. System 400 includes a processor 402 and a machine-readable storage medium 404 communicatively coupled through a system bus. In an example, system 400 may be analogous to storage nodes 104, 106, and 108 of FIG. 1 or storage system 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 404 may be a non-transitory machine-readable medium. Machine-readable storage medium 404 may store instructions 406, 408, 410, 412, and 414. In an example, instructions 406 may be executed by processor 402 to receive, at a first storage node amongst a plurality of storage nodes in a distributed storage system, I/O requests issued by a host system, for a sequential block data of a storage volume distributed across the plurality of storage nodes. Instructions 408 may be executed by processor 402 to determine, by the first storage node, whether the host system is aware or unaware of layout information of the storage volume. If the host system is unware of layout information of the storage volume, instructions 410 may be executed by processor 402 to prefetch, by the first storage node, the sequential block data of the storage volume from remaining storage nodes in the plurality of storage nodes. If the host system is aware of layout information of the storage volume, instructions 412 may be executed by processor 402 to determine, by the first storage node, that the I/O requests by the host system are for the sequential block data of the storage volume. In response to the determination, instructions 414 may be executed by processor 402 to indicate, by the first storage node, to a second storage node amongst the plurality of storage nodes that the I/O requests by the host system are for the sequential block data of the storage volume, before the host system issues I/O requests for a portion of the sequential block data present on the second storage node, to the second storage node.

For the purpose of simplicity of explanation, the example method of FIG. 3 is shown as executing serially, however it is to be understood and appreciated that the present and other examples are not limited by the illustrated order. The example systems of FIGS. 1, 2, and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. A method for prefetching data in a distributed storage system, the method comprising:
receiving, at a first storage node, I/O requests sent by a host system, for sequential data of a storage volume distributed across a plurality of storage nodes in a distributed storage system;
determining, by the first storage node, whether the host system is aware or unaware of layout information of the storage volume;
if the host system is unware of layout information of the storage volume, prefetching, by the first storage node, the sequential data of the storage volume from other nodes of the plurality of storage nodes; and
if the host system is aware of layout information of the storage volume, indicating, by the first storage node, to a second storage node amongst the plurality of storage nodes that the I/O requests by the host system are for the sequential data of the storage volume, before I/O requests for the sequential data on the second storage node are issued by the host system.

2. The method of claim 1, wherein determining whether the host system is unaware of layout information of the storage volume comprises:
determining, by the first storage node, that a Device Specific Module (DSM) specific is present on the host system.

3. The method of claim 2, wherein the DSM is a Multipath I/O (MPIO)-based module.

4. The method of claim 1, wherein in response to receiving the indication from the first storage node, the second storage node to prefetch sequential data of the storage volume that succeeds portion of the sequential data present on the first storage node.

5. The method of claim 1, wherein in response to receiving the indication from the first storage node, the second storage node to indicate to a third storage node that the I/O requests by the host system are for the sequential data of the storage volume, before the third storage node receives the I/O requests for the sequential data from the host system.

6. The method of claim 5, wherein in response to receiving the indication from the second storage node, the third storage node to prefetch sequential data of the storage volume that succeeds portion of the sequential data present on the second storage node.

7. A storage system for prefetching data in a distributed storage system, the system comprising:
an I/O module to receive I/O requests issued by a host system for sequential block data of a storage volume distributed across a plurality of storage systems;
a determination module to determine whether the host system is aware or unaware of layout information of the storage volume;
a prefetch module to prefetch the sequential block data of the storage volume from the plurality of storage nodes, if the host system is unware of layout information of the storage volume; and
an indicator module to indicate to a second storage system amongst the plurality of storage nodes that the I/O requests by the host system are for the sequential block data of the storage volume, if the host system is aware of layout information of the storage volume.

8. The system of claim 7, wherein the system includes a first part of the sequential data.

9. The system of claim 7, wherein the second storage system includes a second part of the sequential data.

10. The system of claim 7, wherein the indicator module to indicate to the second storage node before I/O requests for the sequential block data on the second storage node are issued by the host system to the second storage node.

11. A non-transitory machine-readable storage medium comprising instructions for prefetching data in a distributed storage system, the instructions executable by a processor to:
receive, at a first storage node, I/O requests issued by a host system, for a sequential block data of a storage volume distributed across a plurality of storage nodes;
determine, by the first storage node, whether the host system is aware or unaware of layout information of the storage volume;
if the host system is unware of layout information of the storage volume, prefetch, by the first storage node, the sequential block data of the storage volume from remaining storage nodes in the plurality of storage nodes;
if the host system is aware of layout information of the storage volume:
determine, by the first storage node, that the I/O requests by the host system are for the sequential block data of the storage volume; and
in response to the determination, indicate, by the first storage node, to a second storage node amongst the plurality of storage nodes that the I/O requests by the host system are for the sequential block data of the storage volume, before I/O requests for the sequential block data on the second storage node are issued by the host system.

12. The storage medium of claim 11, wherein the first storage node includes a first portion of the sequential block data.

13. The storage medium of claim 12, wherein the sequential block data on the second storage node succeeds the sequential block data on the first storage node.

14. The storage medium of claim 11, wherein in response to the indication, the sequential block data on the second storage node is prefetched on the second storage node, before I/O requests for the sequential block data on the second storage node are issued by the host system.

15. The storage medium of claim 11, wherein the I/O requests include sequential I/O requests sent by the host system.
